(19) United States
(12) Patent Application Publication
(10) Pub. No.: US 2025/0254318 A1
(43) Pub. Date: Aug. 7, 2025

(54) OWN VEHICLE, IMAGE PROCESSING DEVICE, AND STORAGE MEDIUM

(71) Applicants: TOYOTA JIDOSHA KABUSHIKI KAISHA, Aichi-ken (JP); DENSO CORPORATION, Aichi-pref (JP)

(72) Inventor: Tomohiro SASANO, Nisshin-shi (JP)

(21) Appl. No.: 19/037,287

(22) Filed: Jan. 27, 2025

(30) Foreign Application Priority Data
Feb. 2, 2024 (JP) 2024-015009

(51) Int. Cl. H04N 19/134; G08G 1/04

(52) U.S. Cl. CPC H04N 19/134; G08G 1/04

(57) ABSTRACT

An own vehicle includes a camera, a radar, a traveling speed sensor, and an image compressor that compresses an image in front of the own vehicle captured by the camera, wherein when the traveling speed of the own vehicle is equal to or less than a first threshold value, the image compressor compresses the image in front of the own vehicle into an image of a first image quality, when the traveling speed of the own vehicle is more than the first threshold value and also when the distance between the own vehicle and a preceding vehicle measured by the radar is less than a second threshold value, the image compressor compresses the image in front of the own vehicle into an image of a second image quality that is a higher image quality than the first image quality.

### CROSS-REFERENCE TO RELATED APPLICATION

This application claims priority to Japanese Patent Application No. 2024-015009 filed on Feb. 2, 2024, incorporated herein by reference in its entirety.

### BACKGROUND

### 1. Technical Field

The present disclosure relates to an own vehicle, an image processing device, and a storage medium.

### 2. Description of Related Art

Japanese Unexamined Patent Application Publication (Translation of PCT application) No. 2012-503817 describes a technology of removing privacy information from images by reducing spatial resolution to a level that the privacy information cannot be recognized in the image. The technology described in JP 2012-503817 A uses depth image information coming from a 3-D point cloud delivered by synchronized laser or range sensor, 3D camera (cameras which add to image depth information) or depth information as results of image processing based on photogram metric approach, for example by processing stereo images, or other image processing techniques that lead to positioning or depth information in imagery. According to the technology described in JP 2012-503817 A, by applying a blurring algorithm to parts or pixels of an image for which the spatial resolution is above a predefined threshold, the spatial resolution is reduced to at least the predefined threshold. According to the technology described in JP 2012-503817 A, license plates and human faces that are clearly visible in an original image cannot be recognized in the blurred transformed image, so that privacy information related to license plates and human faces is protected.

### SUMMARY

As described above, according to the technology described in JP 2012-503817 A, depth image information synchronized with images, or depth information as results of image processing based on photogram metric approach or other image processing techniques that lead to positioning or depth information in imagery, needs to be used. On the other hand, for example, when images in front of an own vehicle are acquired by using a camera disposed in an upper portion of the windshield of the own vehicle while the distance (depth information) between the own vehicle and a preceding vehicle is acquired by using a radar or the like disposed around the radiator grille of the own vehicle, the images and the depth information are not synchronized. Moreover, in order to use depth information as results of image processing based on photogram metric approach or other image processing techniques that lead to positioning or depth information in imagery, an image processing device that is capable of complicated image processing needs to be mounted on the own vehicle. That is to say, the technology described in JP 2012-503817 A cannot be easily implemented by using sensors, an image processing device mounted on a general own vehicle, and an attempt to implement the technology described in JP 2012-503817 A may run up costs.

In view of the points as described above, an object of the present disclosure is to provide an own vehicle, an image processing device, and a storage medium that can appropriately remove privacy information included in an image acquired by capturing images in front of the own vehicle.

An aspect of the present disclosure is an own vehicle including: a camera that captures an image in front of the own vehicle; a radar that measures the distance between the own vehicle and a preceding vehicle; a traveling speed sensor that detects the traveling speed of the own vehicle; and an image compressor that compresses the image in front of the own vehicle captured by the camera, wherein when the traveling speed of the own vehicle detected by the traveling speed sensor is equal to or less than a first threshold value, the image compressor compresses the image in front of the own vehicle into an image of a first image quality, when the traveling speed of the own vehicle detected by the traveling speed sensor is more than the first threshold value and also when the distance between the own vehicle and the preceding vehicle measured by the radar is less than a second threshold value, the image compressor compresses the image in front of the own vehicle into an image of a second image quality that is a higher image quality than the first image quality, and when the traveling speed of the own vehicle detected by the traveling speed sensor is more than the first threshold value and also when the distance between the own vehicle and the preceding vehicle measured by the radar is equal to or more than the second threshold value, the image compressor compresses the image in front of the own vehicle into an image of a third image quality that is a higher image quality than the second image quality.

An aspect of the present disclosure is an image processing device including: an acquirer that acquires an image in front of an own vehicle captured by a camera mounted on the own vehicle, the distance between the own vehicle and a preceding vehicle, and the traveling speed of the own vehicle; and an image compressor that compresses the image in front of the own vehicle acquired by the acquirer, wherein when the traveling speed of the own vehicle acquired by the acquirer is equal to or less than a first threshold value, the image compressor compresses the image in front of the own vehicle into an image of a first image quality, when the traveling speed of the own vehicle acquired by the acquirer is more than the first threshold value and also when the distance between the own vehicle and the preceding vehicle acquired by the acquirer is less than a second threshold value, the image compressor compresses the image in front of the own vehicle into an image of a second image quality that is a higher image quality than the first image quality, and when the traveling speed of the own vehicle acquired by the acquirer is more than the first threshold value and also when the distance between the own vehicle and the preceding vehicle acquired by the acquirer is equal to or more than the second threshold value, the image compressor compresses the image in front of the own vehicle into an image of a third image quality that is a higher image quality than the second image quality.

An aspect of the present disclosure is a storage medium that stores a program for causing a processor to execute: acquiring an image in front of an own vehicle captured by a camera mounted on the own vehicle, the distance between the own vehicle and a preceding vehicle, and the traveling speed of the own vehicle; and compressing the image in front of the own vehicle acquired in the acquiring, wherein in the compressing of the image, when the traveling speed of the own vehicle acquired in the acquiring is equal to or less than a first threshold value, the image in front of the own vehicle is compressed into an image of a first image quality, when the traveling speed of the own vehicle acquired in the acquiring is more than the first threshold value and also when the distance between the own vehicle and the preceding vehicle acquired in the acquiring is less than a second threshold value, the image in front of the own vehicle is compressed into an image of a second image quality that is a higher image quality than the first image quality, and when the traveling speed of the own vehicle acquired in the acquiring is more than the first threshold value and also when the distance between the own vehicle and the preceding vehicle acquired in the acquiring is equal to or more than the second threshold value, the image in front of the own vehicle is compressed into an image of a third image quality that is a higher image quality than the second image quality.

According to the present disclosure, it is possible to appropriately remove privacy information included in an image acquired by capturing images in front of the own vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of an own vehicle 1 to which an image processing device 14 according to a first embodiment is applied;

FIG. 2 is a diagram for describing a shortest side distance DT2 and the like;

FIG. 3 is a diagram for describing a situation in which a person PS exists right in front of the own vehicle 1; and

FIG. 4 is a flowchart for describing an example of processes that are executed by a processor 143 of the image processing device 14 according to the first embodiment.

### DETAILED DESCRIPTION OF EMBODIMENTS

Hereinafter, embodiments of an own vehicle, an image processing device, and a storage medium of the present disclosure are described with reference to the drawings.

### First Embodiment

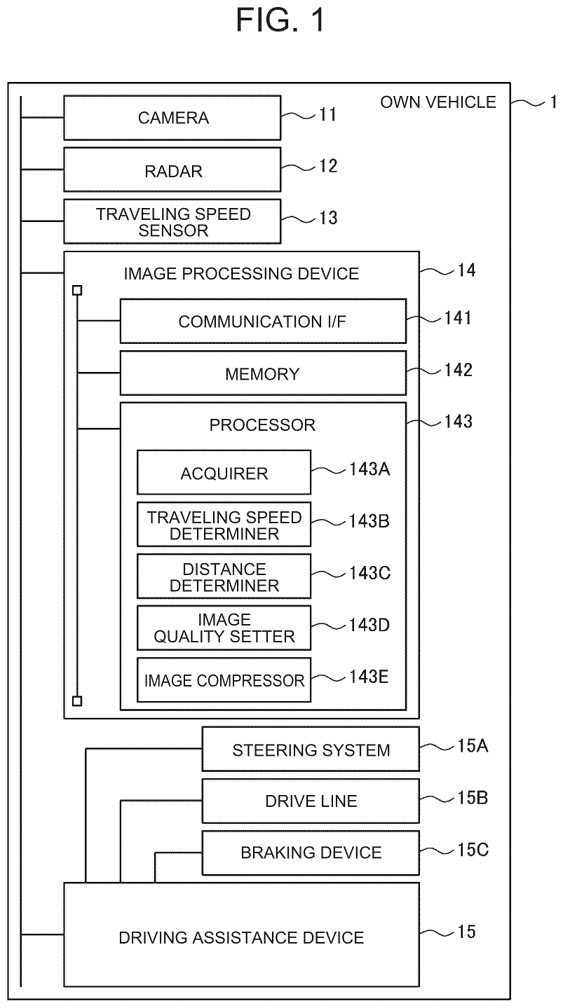

FIG. 1 shows an example of an own vehicle 1 to which an image processing device 14 according to a first embodiment is applied.

In the example shown in FIG. 1, the own vehicle 1 includes a camera 11, a radar 12, a traveling speed sensor 13, the image processing device 14, a driving assistance device 15, a steering system (steering actuator) 15A, a drive line (drive actuator) 15B, and a braking device (braking actuator) 15C.

In the example shown in FIG. 1, the own vehicle 1 includes the camera 11 and the radar 12 as surrounding situation sensors, and includes the traveling speed sensor 13 as a vehicle state sensor. In another example, the own vehicle 1 may include a surrounding situation sensor (for example, a laser imaging detection and ranging (LiDAR), a sonar, or the like) other than the camera 11 and the radar 12, and may include a vehicle state sensor (for example, an acceleration sensor, a yaw rate sensor, or the like) other than the traveling speed sensor 13. In still another example, the own vehicle 1 may include, for example, a global positioning system (GPS) device or the like that measures the position and orientation of the own vehicle 1, as well as a map database in which map information indicating lane layout, road shapes, and the like is stored.

In the example shown in FIG. 1, the camera 11 captures images in front of the own vehicle 1 and transmits image data on the images in front of the own vehicle 1 to the image processing device 14 and the driving assistance device 15.

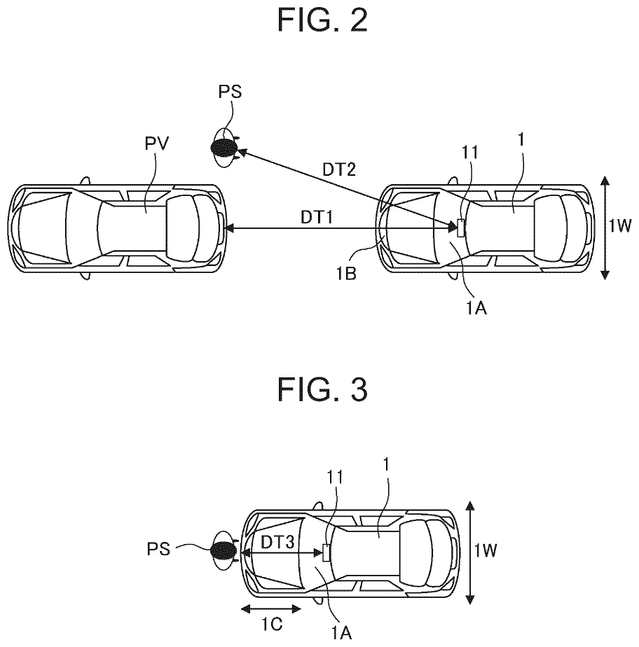

In the example shown in FIG. 1, the camera 11 is disposed in an upper portion, and at a center position in the width direction of the own vehicle 1 (the up-down direction of FIG. 2), of a windshield 1A (see FIG. 2) of the own vehicle 1. In another example, the camera 11 may be disposed at a different position from the example shown in FIG. 1.

In the example shown in FIG. 1, the camera 11 is a stereo camera. In another example, the camera 11 may be another type of camera than the stereo camera, such as a monocular camera.

In the example shown in FIG. 1, the radar 12 measures the distance between the own vehicle 1 and a preceding vehicle PV (see FIG. 2) and transmits a measurement result to the image processing device 14 and the driving assistance device 15.

In the example shown in FIG. 1, the radar 12 is disposed around a radiator grille 1B (see FIG. 2) of the own vehicle 1. In another example, the radar 12 may be disposed at a different position from the example shown in FIG. 1.

In the example shown in FIG. 1, the radar 12 is a millimeter-wave radar. In another example, the radar 12 may be another type of radar than the millimeter-wave radar, such as a 24 GHz-band radar.

In the example shown in FIG. 1, the traveling speed sensor 13 detects the traveling speed of the own vehicle 1 and transmits a detection result to the image processing device 14 and the driving assistance device 15.

The driving assistance device 15 is configured by using a computer (driving assistance electronic control unit (ECU)) including a communication interface (I/F), a memory, and a processor. Examples of the steering system 15A include a power steering system, a steer-by-wire steering system, a rear-wheel steering system, and the like. The drive line 15B has a function of accelerating the own vehicle 1. Examples of the drive line 15B include an engine, an electric vehicle (EV) system, a hybrid system, a fuel cell system, and the like. The braking device 15C has a function of decelerating the own vehicle 1. Examples of the braking device 15C include a hydraulic brake, an electric regenerative brake, and the like.

The driving assistance device 15 transmits, to the steering system 15A, a control signal that causes the steering system 15A to operate according to a steering operation or the like by a driver of the own vehicle 1. Moreover, the driving assistance device 15 transmits, to the drive line 15B, a control signal that causes the drive line 15B to operate according to an acceleration operation or the like by the driver of the own vehicle 1, and transmits, to the braking device 15C, a control signal that causes the braking device 15C to operate according to a braking operation or the like by the driver of the own vehicle 1.

Further, the driving assistance device 15 has driving assistance functionality that performs control and the like of the own vehicle 1 in place of the driver of the own vehicle 1. Specifically, the driving assistance device 15 includes functions such as adaptive cruise control (ACC) and forward collision warning (FCW).

In another example, the driving assistance device 15 may include another driving assistance function (for example, traffic sign recognition (TSR), lane keeping assist system (LKAS), or the like) than ACC, FCW.

In the example shown in FIG. 1, the image processing device 14 is configured by using a computer (for example, a camera ECU or the like) including a communication interface 141, a memory 142, and a processor 143. The processor 143 includes a function as an acquirer 143A, a function as a traveling speed determiner 143B, a function as a distance determiner 143C, a function as an image quality setter 143D, and a function as an image compressor 143E.

The acquirer 143A acquires the images in front of the own vehicle 1 captured by the camera 11 (the image data on the images in front of the own vehicle 1 transmitted by the camera 11). Moreover, the acquirer 143A acquires the distance DT1 between the own vehicle 1 and the preceding vehicle PV measured by the radar 12 (the measurement result transmitted by the radar 12). Further, the acquirer 143A acquires the traveling speed of the own vehicle 1 detected by the traveling speed sensor 13 (the detection result transmitted by the traveling speed sensor 13).

The traveling speed determiner 143B determines whether or not the traveling speed of the own vehicle 1 detected by the traveling speed sensor 13 is equal to or less than a first threshold value.

In the example shown in FIG. 1, the first threshold value used in determination by the traveling speed determiner 143B is set to zero km/h. In other words, when the own vehicle 1 is stopped, the traveling speed determiner 143B determines that the traveling speed of the own vehicle 1 is equal to or less than the first threshold value, and when the own vehicle 1 is not stopped (that is, when the own vehicle 1 is traveling (moving)), the traveling speed determiner 143B determines that the traveling speed of the own vehicle 1 is not equal to or less than the first threshold value.

In another example, the acquirer 143A may acquire, for example, a gear shift position sensor signal or the like, and the traveling speed determiner 143B may determine, for example, based on the gear shift position sensor signal or the like and the detection result from the traveling speed sensor 13, whether or not the traveling speed of the own vehicle 1 detected by the traveling speed sensor 13 is equal to or less than the first threshold value. In the example, when the gear shift position is “R (reverse)”, the traveling speed determiner 143B determines that the traveling speed of the own vehicle 1 is equal to or less than the first threshold value even if the traveling speed of the own vehicle 1 detected by the traveling speed sensor 13 is more than zero km/h. When the gear shift position is “D or the like (a position in which the own vehicle 1 can move forward)”, the traveling speed determiner 143B determines that the traveling speed of the own vehicle 1 is equal to or less than the first threshold value when the traveling speed of the own vehicle 1 detected by the traveling speed sensor 13 is zero km/h, and the traveling speed determiner 143B determines that the traveling speed of the own vehicle 1 is not equal to or less than the first threshold value when the traveling speed of the own vehicle 1 detected by the traveling speed sensor 13 is more than zero km/h.

In the example shown in FIG. 1, the distance determiner 143C determines whether or not the distance DT1 (see FIG. 2) between the own vehicle 1 and the preceding vehicle PV measured by the radar 12 is less than a second threshold value. The second threshold value used in determination by the distance determiner 143C is set to a shortest side distance DT2, which will be described with reference to FIG. 2.

FIG. 2 is a diagram for describing the shortest side distance DT2 and the like. As shown in FIG. 2, the shortest side distance DT2 is a distance determined by (that is, that can be calculated from) a width 1W of the own vehicle 1 and an angle of view of the camera 11. More specifically, the shortest side distance DT2 (second threshold value) is the shortest distance to a position at which a person PS existing in front and on a side of the own vehicle 1 can be included in an image in front of the own vehicle 1 captured by the camera 11 when the own vehicle 1 is traveling at a higher traveling speed than the first threshold value.

In the example shown in FIG. 1, the image compressor 143E performs a process of compressing an image in front of the own vehicle 1 captured by the camera 11. The image quality setter 143D sets an image quality for the image after subjected to the process by the image compressor 143E. In other words, the image quality setter 143D sets a target image quality to be produced by the image compression process performed by the image compressor 143E.

More specifically, when the traveling speed of the own vehicle 1 detected by the traveling speed sensor 13 is equal to or less than the first threshold value, the image quality setter 143D sets the (target) image quality for the image to a first image quality, and the image compressor 143E compresses the image in front of the own vehicle 1 captured by the camera 11 into an image of the first image quality.

When the traveling speed of the own vehicle 1 is equal to or less than the first threshold value, there is a possibility that a person PS (see FIG. 3) exists right in front of the own vehicle 1.

Accordingly, in the example shown in FIG. 1, even if an image of the person PS existing right in front of the own vehicle 1 is captured by the camera 11 when the traveling speed of the own vehicle 1 is equal to or less than the first threshold value, the image compressor 143E, in order to appropriately protect privacy of the person PS, compresses the image in front of the own vehicle 1 captured by the camera 11 into an image of the first image quality such that the person PS included in the image captured by the camera 11 is unrecognizable.

In other words, in the example shown in FIG. 1, the first image quality set by the image quality setter 143D is an image quality with which, assuming that an image of a person PS right in front of the own vehicle 1 is captured by the camera 11, the person PS right in front of the own vehicle 1 included in the image captured by the camera 11 is unrecognizable (that is, an image quality that makes the person PS right in front of the own vehicle 1 unrecognizable as a result of the image compression process of converting an image quality at the time of capturing the image into the first image quality).

FIG. 3 is a diagram for describing a situation in which a person PS exists right in front of the own vehicle 1. As shown in FIG. 3, when a person PS exists right in front of the own vehicle 1, a distance DT3 between the person PS and the own vehicle 1 (more precisely, the distance DT3 between the person PS and the camera 11 of the own vehicle 1) is determined by (that is, can be calculated from) a length IC of a front nose of the own vehicle 1.

In the example shown in FIG. 1, when the traveling speed of the own vehicle 1 detected by the traveling speed sensor 13 is more than the first threshold value and also when the distance DT1 between the own vehicle 1 and the preceding vehicle PV measured by the radar 12 is less than the second threshold value (shortest side distance DT2), the image quality setter 143D sets the (target) image quality for the image to a second image quality that is a higher image quality than the first image quality, and the image compressor 143E compresses the image in front of the own vehicle 1 captured by the camera 11 into an image of the second image quality.

In other words, the image compressor 143E performs compression into the second image quality with which it is impossible to recognize the license number of the preceding vehicle PV that is a longer distance than the distance DT3 away from the own vehicle 1 but is less than the shortest side distance DT2 away from the own vehicle 1 (that is, the second image quality with which not only the license number of the preceding vehicle PV cannot be recognized, but the person PS existing between the own vehicle 1 and the preceding vehicle PV cannot be recognized either).

In other words, in the example shown in FIG. 1, the second image quality is an image quality with which, assuming that an image of the preceding vehicle PV at a position that is less than the second threshold value (shortest side distance DT2) away from the own vehicle 1 is captured by the camera 11, the license number of the preceding vehicle PV included in the image captured by the camera 11 is unrecognizable (that is, an image quality that makes the license number of the preceding vehicle PV unrecognizable as a result of the image compression process of converting an image quality at the time of capturing the image into the second image quality).

In the example shown in FIG. 1, when the traveling speed of the own vehicle 1 detected by the traveling speed sensor 13 is more than the first threshold value and also when the distance DT1 between the own vehicle 1 and the preceding vehicle PV measured by the radar 12 is equal to or more than the second threshold value (shortest side distance DT2), the image quality setter 143D sets the (target) image quality for the image to a third image quality that is a higher image quality than the second image quality, and the image compressor 143E compresses the image in front of the own vehicle 1 captured by the camera 11 into an image of the third image quality.

In other words, in the example shown in FIG. 1, the third image quality is an image quality with which, assuming that a person PS (see FIG. 2) exists at a position that is the second threshold value (shortest side distance DT2) away from the own vehicle 1 and that is in front and on a side of the own vehicle 1, the person PS is unrecognizable.

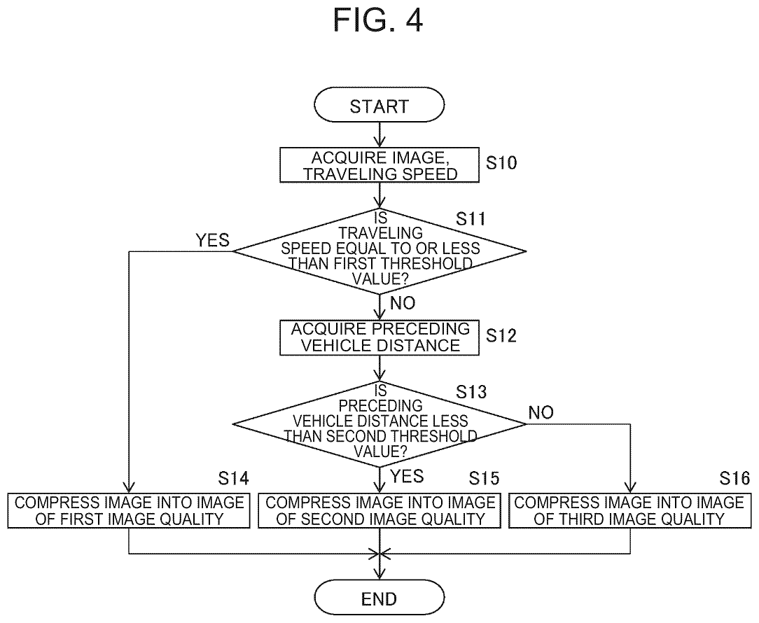

FIG. 4 is a flowchart for describing an example of processes that are executed by the processor 143 of the image processing device 14 according to the first embodiment.

In the example shown in FIG. 4, in step S10, the acquirer 143A acquires an image in front of the own vehicle 1 captured by the camera 11, and the traveling speed of the own vehicle 1 detected by the traveling speed sensor 13.

In step S11, the traveling speed determiner 143B determines whether or not the traveling speed of the own vehicle 1 acquired in step S10 is equal to or less than the first threshold value. The process moves to step S12 when the result is NO, and moves to step S14 when the result is YES.

In step S12, the acquirer 143A acquires the distance (preceding vehicle distance) DT1 between the own vehicle 1 and the preceding vehicle PV measured by the radar 12.

In step S13, the distance determiner 143C determines whether or not the distance (preceding vehicle distance) DT1 between the own vehicle 1 and the preceding vehicle PV acquired in step S12 is less than the second threshold value (shortest side distance DT2). The process moves to step S15 when the result is YES, and moves to step S16 when the result is NO.

In step S14, since a person PS (see FIG. 3) can exist right in front of the own vehicle 1, in order to appropriately protect privacy of the person PS even if an image of the person PS existing right in front of the own vehicle 1 is captured by the camera 11, the image quality setter 143D sets the (target) image quality for the image to the first image quality, and the image compressor 143E compresses the image in front of the own vehicle 1 captured by the camera 11 into an image of the first image quality such that the person PS included in the image captured by the camera 11 is unrecognizable.

In step S15, since it is necessary to make the license number of the preceding vehicle PV that is a longer distance than the distance DT3 (see FIG. 3) away from the own vehicle 1 but is less than the shortest side distance DT2 (see FIG. 2) away from the own vehicle 1 unrecognizable (that is, to make not only the license number of the preceding vehicle PV but also a person PS existing between the own vehicle 1 and the preceding vehicle PV unrecognizable), the image quality setter 143D sets the (target) image quality for the image to the second image quality that is a higher image quality than the first image quality, and the image compressor 143E compresses the image in front of the own vehicle 1 captured by the camera 11 into an image of the second image quality.

In step S16, since it is necessary to make a person PS (see FIG. 2) existing at a position that is the second threshold value (shortest side distance DT2) away from the own vehicle 1 and that is in front and on a side of the own vehicle 1 unrecognizable, the image quality setter 143D sets the (target) image quality for the image to the third image quality that is a higher image quality than the second image quality, and the image compressor 143E compresses the image in front of the own vehicle 1 captured by the camera 11 into an image of the third image quality.

When analysis (verification) and the like of the driving assistance functionality of the own vehicle 1 are performed, images in front of the own vehicle 1 captured by the camera 11 are very useful. When the face of a person PS and a license plate are included in an image in front of the own vehicle 1 captured by the camera 11, careful attention to privacy violation (legal compliance) is needed.

On the other hand, if the image quality of images in front of the own vehicle 1 captured by the camera 11 is uniformly lowered, there is a possibility that analysis (verification) and the like of the driving assistance functionality of the own vehicle 1 cannot be appropriately performed.

In view of such respects, the own vehicle 1 to which the image processing device 14 according to the first embodiment is applied performs the image compression process in stages according to the traveling speed of the own vehicle 1 and the distance between the own vehicle 1 and the preceding vehicle PV. Thus, it is possible to appropriately pay careful attention to privacy violation (achieve legal compliance) without running up costs, and to use images in front of the own vehicle 1 captured by the camera 11 for analysis (verification) and the like of driving assistance functionality.

### Second Embodiment

An own vehicle 1 to which an image processing device 14 according to a second embodiment is applied is configured similarly to the own vehicle 1 to which the image processing device 14 according to the first embodiment is applied as shown in FIG. 1, except a point described below.

As described above, in the example shown in FIG. 1, the first threshold value that is used in determination by the traveling speed determiner 143B is set to zero km/h.

In contrast, in the own vehicle 1 to which the image processing device 14 according to the second embodiment is applied, the first threshold value that is used in determination by the traveling speed determiner 143B is set to a predetermined low-speed value (for example, five km/h or the like). The reason is that when the traveling speed of the own vehicle 1 is low, a person PS can keep a position right in front of the own vehicle 1, for example, by walking backward in time to the movement of the own vehicle 1, and the face of the person PS can be included in an image in front of the own vehicle 1 captured by the camera 11.

### Third Embodiment

An own vehicle 1 to which an image processing device 14 according to a third embodiment is applied is configured similarly to the own vehicle 1 to which the image processing device 14 according to the first embodiment is applied as shown in FIG. 1, except a point described below.

As described above, in the example shown in FIG. 1, the own vehicle 1 includes the driving assistance device 15.

In contrast, the own vehicle 1 to which the image processing device 14 according to the third embodiment is applied includes an automated driving control device (not shown) in place of the driving assistance device 15. In the own vehicle 1 to which the image processing device 14 according to the third embodiment is applied, three processes of recognition (for example, recognition of a surrounding environment around the own vehicle 1, recognition of the position of the own vehicle 1, recognition of the behavior of the own vehicle 1, and the like), determination (for example, determination of whether or not the own vehicle 1 should accelerate, decelerate, turn, or the like), and operation (for example, operation and the like to move the steering system 15A, the drive line 15B, the braking device 15C, or the like), which are performed mainly by the driver of the own vehicle 1 in the example shown in FIG. 1, are performed by the automated driving control device (for example, an automated driving ECU).

### Fourth Embodiment

An own vehicle 1 to which an image processing device 14 according to a fourth embodiment is applied is configured similarly to the own vehicle 1 to which the image processing device 14 according to the first embodiment is applied as shown in FIG. 1, except a point described below.

As described above, in the example shown in FIG. 1, the distance between the own vehicle 1 and the preceding vehicle PV is measured by the radar 12 included as a surrounding situation sensor in the own vehicle 1.

In contrast, in the own vehicle 1 to which the image processing device 14 according to the fourth embodiment is applied, the distance between the own vehicle 1 and the preceding vehicle PV is acquired by using a surrounding situation sensor other than the radar 12, included in the own vehicle 1.

In a first example of the own vehicle 1 to which the image processing device 14 according to the fourth embodiment is applied, the own vehicle 1 includes a stereo camera (surrounding situation sensor) as the camera 11, and the distance between the own vehicle 1 and the preceding vehicle PV is acquired by using a plurality of images in front of the own vehicle 1 captured by the stereo camera.

In a second example of the own vehicle 1 to which the image processing device 14 according to the fourth embodiment is applied, the own vehicle 1 includes a LiDAR as a surrounding situation sensor, and the distance between the own vehicle 1 and the preceding vehicle PV is acquired by using a result of detection by the LiDAR.

In a third example of the own vehicle 1 to which the image processing device 14 according to the fourth embodiment is applied, the own vehicle 1 includes a sonar as a surrounding situation sensor, and the distance between the own vehicle 1 and the preceding vehicle PV is acquired by using a result of detection by the sonar.

Although embodiments of the own vehicle, the image processing device, and the storage medium of the present disclosure have been described hereinabove with reference to the drawings, the own vehicle, the image processing device, and the storage medium of the present disclosure are not limited to the embodiments described above, and changes can be made as appropriate without departing from the scope of the gist of the present disclosure. The configuration in each example in the embodiments may be combined as appropriate. Although the processes performed by the image processing device 14 are described as software processes performed by executing the program in each example in the embodiments, the processes performed by the image processing device 14 may be processes performed by hardware. Alternatively, the processes performed by the image processing device 14 may be processes implemented by software and hardware in combination. The program stored in the memory 142 of the image processing device 14 (the program implementing the functionality of the processor 143 of the image processing device 14) may be recorded on a computer-readable recording medium, such as a semiconductor memory, a magnetic recording medium, or an optical recording medium, and provided, distributed, and the like. The memory is an example of a storage medium.

What is claimed is:

1. An own vehicle comprising:
a camera that captures an image in front of the own vehicle;
a radar that measures a distance between the own vehicle and a preceding vehicle;
a traveling speed sensor that detects a traveling speed of the own vehicle; and
an image compressor that compresses the image in front of the own vehicle captured by the camera, wherein
when the traveling speed of the own vehicle detected by the traveling speed sensor is equal to or less than a first threshold value, the image compressor compresses the image in front of the own vehicle into an image of a first image quality,
when the traveling speed of the own vehicle detected by the traveling speed sensor is more than the first threshold value and also when the distance between the own vehicle and the preceding vehicle measured by the radar is less than a second threshold value, the image compressor compresses the image in front of the own vehicle into an image of a second image quality that is a higher image quality than the first image quality, and
when the traveling speed of the own vehicle detected by the traveling speed sensor is more than the first threshold value and also when the distance between the own vehicle and the preceding vehicle measured by the radar is equal to or more than the second threshold value, the image compressor compresses the image in front of the own vehicle into an image of a third image quality that is a higher image quality than the second image quality.

2. The own vehicle according to claim 1, wherein:
the first image quality is an image quality with which, assuming that an image of a person right in front of the own vehicle is captured by the camera, the person right in front of the own vehicle included in the image captured by the camera is unrecognizable;
the second image quality is an image quality with which, assuming that an image of the preceding vehicle at a position that is less than the second threshold value away from the own vehicle is captured by the camera, a license number of the preceding vehicle included in the image captured by the camera is unrecognizable; and
the third image quality is an image quality with which, assuming that a person exists at a position that is the second threshold value away from the own vehicle and that is in front and on a side of the own vehicle, the person is unrecognizable.

3. The own vehicle according to claim 2, wherein the second threshold value is a distance determined by a width of the own vehicle and an angle of view of the camera, and is a shortest distance to the position at which it is possible that the person existing in front and on a side of the own vehicle is included in the image in front of the own vehicle captured by the camera when the own vehicle travels at a higher traveling speed than the first threshold value.

4. An image processing device comprising:
an acquirer that acquires an image in front of an own vehicle captured by a camera mounted on the own vehicle, a distance between the own vehicle and a preceding vehicle, and a traveling speed of the own vehicle; and
an image compressor that compresses the image in front of the own vehicle acquired by the acquirer, wherein
when the traveling speed of the own vehicle acquired by the acquirer is equal to or less than a first threshold value, the image compressor compresses the image in front of the own vehicle into an image of a first image quality,
when the traveling speed of the own vehicle acquired by the acquirer is more than the first threshold value and also when the distance between the own vehicle and the preceding vehicle acquired by the acquirer is less than a second threshold value, the image compressor compresses the image in front of the own vehicle into an image of a second image quality that is a higher image quality than the first image quality, and
when the traveling speed of the own vehicle acquired by the acquirer is more than the first threshold value and also when the distance between the own vehicle and the preceding vehicle acquired by the acquirer is equal to or more than the second threshold value, the image compressor compresses the image in front of the own vehicle into an image of a third image quality that is a higher image quality than the second image quality.

5. A non-transitory storage medium storing a program that causes a processor to execute:
acquiring an image in front of an own vehicle captured by a camera mounted on the own vehicle, a distance between the own vehicle and a preceding vehicle, and a traveling speed of the own vehicle; and
compressing the image in front of the own vehicle acquired in the acquiring, wherein in the compressing of the image,
when the traveling speed of the own vehicle acquired in the acquiring is equal to or less than a first threshold value, the image in front of the own vehicle is compressed into an image of a first image quality,
when the traveling speed of the own vehicle acquired in the acquiring is more than the first threshold value and also when the distance between the own vehicle and the preceding vehicle acquired in the acquiring is less than a second threshold value, the image in front of the own vehicle is compressed into an image of a second image quality that is a higher image quality than the first image quality, and
when the traveling speed of the own vehicle acquired in the acquiring is more than the first threshold value and also when the distance between the own vehicle and the preceding vehicle acquired in the acquiring is equal to or more than the second threshold value, the image in front of the own vehicle is compressed into an image of a third image quality that is a higher image quality than the second image quality.
